(19) United States
(12) Patent Application Publication
(10) Pub. No.: US 2024/0413926 A1
(43) Pub. Date: Dec. 12, 2024

(54) PARALLEL UPLINK TRANSMISSIONS IN A WIRELESS COMMUNICATION NETWORK

(71) Applicant: Nokia Technologies Oy, Espoo (FI)

(72) Inventors: Matha DEGHEL, Paris (FR); Keeth Saliya Jayasinghe LADDU, Espoo (FI)

(73) Assignee: Nokia Technologies Oy, Espoo (FI)

(21) Appl. No.: 18/700,489

(22) PCT Filed: Oct. 14, 2021
(86) PCT No.: PCT/EP2021/078394

§ 371 Date: Apr. 11, 2024

(51) Int. Cl. H04L 1/00

(52) U.S. Cl. CPC H04L 1/0009; H04L 1/0003

(57) ABSTRACT

Various example embodiments relate to a solution for wireless communication. A user device may be configured to receive, from a network device, at least one parameter for a first uplink transmission from the user device, the at least one parameter relating to at least one of one or more modulation orders or one or more coding rates for the first uplink transmission; and utilize the at least one parameter for the first uplink transmission when a parallel uplink transmission is detected at the user device. Devices, methods, and computer programs are disclosed.

### TECHNICAL FIELD

Various example embodiments generally relate to the field of wireless communications. In particular, some example embodiments relate to a solution for enhancing parallel or simultaneous transmissions in a wireless communication network.

### BACKGROUND

A mobile device, for example, user equipment, may have more than one uplink (UL) transmission at a certain point of time, for example, a physical uplink control channel (PUCCH) and a physical uplink shared channel (PUSCH). The PUCCH and PUSCH are defined in more detail, for example, in the 3^{rd} generation partnership project (3GPP) standards.

As an example, the PUSCH is a physical uplink channel that carries user data. A modulation and coding scheme (MSC) may be used for the PUSCH. The MCS may be determined from a MCS field indicated via downlink control information (DCI) (at least for a dynamically scheduled PUSCH), considering a (regular) MCS table (where the considered table depends on whether 256QAM is not configured or not). Some of the combinations/entries of the MCS field may be reserved and used for retransmissions purpose only. It is possible to configured an alternative MCS table providing lower spectral efficiency values, mainly targeting high reliability. Whether to use a regular table or a more robust table, this may be indicated by the radio network temporary identifier (RNTI) scheduling a UE. The cell radio network temporary identifier (C-RNTI) may imply that the regular table should be used and the MCS-C-RNTI implies that the more robust table should be used.

Further, as an example, the PUCCH in new radio (NR) may be used to carry uplink control information (UCI), such as a scheduling request (SR), which could also be used or dedicated for a beam failure recovery (BMF) request or a link failure recovery (LRR) request), a hybrid automatic repeat request acknowledgement (HARQ-ACK), and channel state information (CSI). The PUCCH Format 2, 3 and 4 may carry HARQ-ACK, SR (which may be used for BFR or LRR), and/or CSI, whereas Format 0 and 1 can only carry SR and/or up to two HARQ-ACK bits. Each format has a format configuration in the PUCCH configuration.

A PUCCH resource may consist of the following parameters (as defined, for example, in 3GPP TS 38.331):
a PUCCH resource index, used to identify the PUCCH resource,
a configuration for a PUCCH format, which contains, for example, the number of Orthogonal Frequency Division Multiplexing (OFDM) symbols and the number of physical resource blocks (PRB) (and, for formats 1 and 4, an orthogonal cover code (OCC) related parameters), the maxCodeRate, the number of PRBs (nrofPRBs) which represents the maximum number of PRBs (at least for formats 2 and 3),
an index of the first PRB prior to frequency hopping or for no frequency hopping,
an index of the first PRB after frequency hopping (if any).

In Rel-15, a user equipment (UE) can be configured up to four sets of PUCCH resources, where each PUCCH resource set corresponds to a certain range of UCI (uplink control information) load (this is specified, for example, in 3GPP TS 38.213). The PUCCH resource set 0 can handle UCI payloads up to two bits and thus may only contain PUCCH formats 0 and 1, whereas the other PUCCH resource sets may contain any PUCCH format except format 0 and 1.

Furthermore, Rel-16 NR introduced some enhancements for the PUCCH formats mainly for unlicensed operation. These enhancements are known as an interlaced (PUCCH) transmission. Related parameters and details can be found, for example, in 3GPP TS 38.213 and TS 38.331.

The PUCCH resource determination mainly depends on at least one of: a PUCCH resource indicator (PRI) in DCI, UCI payload size, the first control channel element (CCE) index of the PDCCH carrying the DCI, the total number of CCEs in the control resource set (CORESET) on which the PDCCH carrying the DCI has been transmitted, UCI configuration (such as an (SR) configuration, a CSI configuration, SPS HARQ-ACK configuration).

Further, when the UE needs to send UCI (including at least HARQ-ACK), the PUCCH resource set is determined based on the UCI load, and the PUCCH resource within this set is determined using the PRI (PUCCH resource indicator) in the DCI (downlink control information). On the other hand, the PUCCH resources for SR (scheduling request) and P-CSI (periodic CSI) are semi-statically (radio resource control (RRC)) configured, where the resources are given in the SR and CSI configurations.

Rel-15 NR defined the single transmission reception point (TRP) PUCCH repetition operation on multiple slots for PUCCH formats 1, 3 and 4, where the main objective of the PUCCH repetition is to increase reliability and coverage for the transmitted UCI. For each of these formats, the repetition operation, if enabled, consists in repeating the PUCCH carrying UCI (uplink control information) over multiple consecutive slots.

Specifically, for the PUCCH formats 1, 3, or 4, a UE could be configured via the RRC with a number of slots for repetitions of a PUCCH transmission, where this number is denoted in the specifications by N_{PUCCH}^{repeat} or sometimes by nrofSlots. The PUCCH repetition operation may be described as follows:
the UE should repeat the PUCCH transmission carrying the UCI over the preconfigured number of slots for repetition (i.e. over N_{PUCCH}^{repeat} slots),
the PUCCH repetition/transmission in each of the slots has at least a same number of consecutive symbols and a same number of PRBs,
the PUCCH repetition/transmission in each of the slots has a same first symbol,
the UE is configured whether (or not) to perform frequency hopping for PUCCH repetitions/transmissions in different slots.

PUCCH and PUSCH enhancements for multi-TRP started to be studied in Rel-17 NR. In Rel-17 NR, one of the topics is on “Enhancements on the support for multi-TRP deployment”, and one of the key objectives is the following:
Identify and specify features to improve reliability and robustness for channels other than PDSCH (that is, PDCCH, PUSCH, and PUCCH) using multi-TRP and/or multi-panel, with Rel-16 reliability features as the baseline.

Considering the Rel-17 discussions, a multi-TRP PUCCH scheme could be any of the following: multi-TRP inter-slot PUCCH repetition (known as scheme 1), multi-TRP intra-slot PUCCH repetition (known as scheme 3), multi-TRP PUCCH intra-slot beam hopping (known as scheme 2).

In addition, the support of a single PUCCH resource has been agreed. This implies that a single PUCCH resource will be used for the different (TDM-ed) repetitions towards different TRPs. And up to two spatial relation information may be indicated/activated for a PUCCH resource via a medium access control (MAC) control element (CE), at least in FR2. Further, up to two sets of power control parameters may be indicated/activated for a PUCCH resource via a MAC CE, at least in FR1—where a set may contain p0, pathloss RS ID, and a closed-loop index.

The PUCCH repetition factor (i.e. number of PUCCH repetitions) may be dynamically indicated (e.g. via the DCI) or configured via the RRC. One approach for somewhat dynamic indication is that a PUCCH resource can be associated (via the RRC) with a PUCCH repetition factor. Thus, the PRI (indicated via the DCI) can be used to select a PUCCH resource associated with the required PUCCH repetition factor.

On the other side, for the multi-TRP PUSCH enhancements, an M-TRP TDM-ed PUSCH repetition scheme based on Rel-16 PUSCH repetition Type A and Type B was agreed, where two beams/SRIs are indicated via DCI. Also, the same number of layers per TRP is supported. Specifically, for codebook based PUSCH, the UE is provided with two SRIs and two TPMIs (second field doesn't indicate number of layers) for PUSCH repetition operation. For non-codebook based PUSCH, the UE is provided with two SRIs (second field doesn't indicate number of layers) for PUSCH repetition operation.

Further Multi-TRP/multi-panel enhancements will likely be studied in Rel-18. Such enhancements would essentially consist in allowing simultaneous or parallel PUCCH/PUSCH and PUSCH/PUCCH/sounding reference signal (SRS) transmissions/repetitions from two UE panels.

The PUCCH and the PUSCH may overlap in time. This may result in a situation in which the sum of a PUCCH transmission power and a PUSCH transmission power exceeds a maximum allowed transmit power. The maximum allowed transmit power may be defined per a serving cell or it may be the same for all serving cells. When the sum of the PUCCH transmission power and the PUSCH transmission power exceeds the maximum allowed transmit power, the UE may have to reduce the PUSCH transmission power and/or PUCCH transmission power.

When the PUCCH/PUSCH transmission power is reduced, the PUCCH/PUSCH reception may be negatively impacted. This may especially be the case, when the power reduction is somewhat large.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution for enhancing parallel or simultaneous transmissions in a wireless communication network. This benefit may be achieved by the features of the independent claims. Further implementation forms are provided in the dependent claims, the description, and the drawings.

According to a first aspect, a user device for wireless communication comprises at least one processor, and at least one memory including computer program code. The at least one memory and the computer program code are configured to, with the at least one processor, cause the user device at least to: receive, from a network device, at least one parameter for a first uplink transmission from the user device, the at least one parameter relating to at least one of one or more modulation orders or one or more coding rates for the first uplink transmission; and utilize the at least one parameter for the first uplink transmission when a parallel uplink transmission is detected at the user device.

In an example embodiment, the at least one parameter comprises a second modulation and coding scheme and the utilizing of the at least one parameter comprises: overriding a first modulation and coding scheme for the first uplink transmission with the second modulation and coding scheme.

In an example embodiment, the at least one parameter comprises a modulation and coding scheme offset to a first modulation and coding scheme for the first uplink transmission and the utilizing of the at least one parameter comprises: determining a second modulation and coding scheme at least partly based on the modulation and coding scheme offset; and overriding the first modulation and coding scheme for the first uplink transmission with the second modulation and coding scheme.

In an example embodiment, the at least one parameter comprises at least one modulation and coding scheme table and the utilizing of the at least one parameter comprises: determining a second modulation and coding scheme at least partly based on the at least one modulation and coding scheme table; and overriding a first modulation and coding scheme for the first uplink transmission with the second modulation and coding scheme.

In an example embodiment, the first modulation and coding scheme comprises an initially configured or indicated modulation and coding scheme for the first uplink transmission.

In an example embodiment, the at least one memory and the computer program code are configured to, with the at least one processor, cause the user device at least to: determine at least one of one or more parameters related to a phase tracking reference signal (PTRS) for the first uplink transmission, one or more parameters related to a transmission power value for the first uplink transmission or one or more parameters related to a transport block size (TBS) for the first uplink transmission at least partly based on the second modulation and coding scheme.

In an example embodiment, the at least one parameter comprises a second modulation order or a second coding rate and the utilizing of the at least one parameter comprises: overriding a first modulation order or a first coding rate for the first uplink transmission with the second modulation order or the second coding rate respectively.

In an example embodiment, the at least one parameter comprises a second maximum code rate and the utilizing of the at least one parameter comprises: overriding a first maximum code rate for the first uplink transmission with the second maximum code rate.

In an example embodiment, the at least one parameter comprises a set of maximum code rates and the utilizing of the at least one parameter comprises: determining a second maximum code rate at least partly based on the set of maximum code rates; and overriding a first maximum code rate for the first uplink transmission with the second maximum code rate.

In an example embodiment, the at least one parameter comprises a second maximum number of physical resource blocks and the utilizing of the at least one parameter further comprises: overriding a first maximum number of physical resource blocks for the first uplink transmission with the second maximum number of physical resource blocks; and determining the number of physical resource blocks for the first uplink transmission at least partly based on the second maximum number of physical resource blocks.

In an example embodiment, the at least one parameter comprises a set of maximum number of physical resource blocks and the utilizing of the at least one parameter further comprises: determining a second maximum number of physical resource blocks at least partly based on the set of maximum number of physical resource blocks; and overriding a first maximum number of physical resource blocks for the first uplink transmission with the second maximum number of physical resource blocks.

In an example embodiment, the first modulation order or the first coding rate, the first maximum code rate or the first maximum number of physical resource blocks comprises an initially configured or indicated modulation order or an initially configured or indicated coding rate, an initially configured or indicated maximum code rate or an initially configured or indicated maximum number of physical resource blocks for the first uplink transmission respectively.

In an example embodiment, the at least one memory and the computer program code are configured to, with the at least one processor, cause the user device at least to: receive the at least one parameter via at least one of a radio resource control (RRC) parameter, a medium access control control element (MAC CE) or a downlink control information (DCI).

In an example embodiment, the at least one memory and the computer program code are configured to, with the at least one processor, cause the user device at least to: transmit an indication, to the network device, indicating whether the at least one parameter is in use at the user device.

In an example embodiment, the first uplink transmission comprises a physical uplink control channel (PUCCH) transmission or a physical uplink shared channel (PUSCH) transmission, and the parallel uplink transmission comprises at least one of a PUCCH transmission, a PUSCH transmission, a physical random access channel (PRACH) transmission or a sounding reference signal (SRS) transmission.

In an example embodiment, the parallel uplink transmission comprises one or more of the following: an uplink transmission in a same serving cell or same bandwidth part as the first uplink transmission; an uplink transmission at least partially overlapping in time with the first uplink transmission; and an uplink transmission from a different transmit antenna panel than the first uplink transmission.

According to a second aspect, a network device for wireless communication comprises at least one processor, and at least one memory including computer program code. The at least one memory and the computer program code are configured to, with the at least one processor, cause the network device at least to: determine at least one parameter to be utilized for a first uplink transmission from a user device when a parallel uplink transmission is detected at the user device, the at least one parameter relating to at least one of one or more modulation orders or one or more coding rates for the first uplink transmission; and transmit the at least one parameter to the user device.

In an example embodiment, the at least one parameter comprises a second modulation and coding scheme for the first uplink transmission.

In an example embodiment, the at least one parameter comprises a modulation and coding scheme offset to a first modulation and coding scheme for the first uplink transmission.

In an example embodiment, the at least one parameter comprises at least one modulation and coding scheme table for the first uplink transmission.

In an example embodiment, the at least one parameter comprises a second modulation order or a second coding rate for the first uplink transmission.

In an example embodiment, the at least one parameter comprises a second maximum code rate for the first uplink transmission.

In an example embodiment, the at least one parameter comprises a second maximum number of physical resource blocks for the first uplink transmission.

In an example embodiment, the at least one parameter comprises a set of maximum code rates for the first uplink transmission.

In an example embodiment, the at least one memory and the computer program code are configured to, with the at least one processor, cause the network device at least to: transmit the at least one parameter to the user device via at least one of a radio resource control (RRC) parameter, a medium access control control element (MAC CE) or a downlink control information (DCI).

In an example embodiment, the downlink control information (DCI) comprises a downlink control information (DCI) scheduling the parallel uplink transmission.

In an example embodiment, the at least one memory and the computer program code are configured to, with the at least one processor, cause the network device at least to: receive an indication from the user device indicating whether the at least one parameter is in use at the user device.

In an example embodiment, the first uplink transmission comprises a physical uplink control channel (PUCCH) transmission or a physical uplink shared channel (PUSCH) transmission, and the parallel uplink transmission comprises at least one of a PUCCH transmission, a PUSCH transmission, a physical random access channel (PRACH) transmission or a sounding reference signal (SRS) transmission.

In an example embodiment, the parallel uplink transmission comprises one or more of the following: an uplink transmission in a same serving cell or same bandwidth part as the first uplink transmission; an uplink transmission at least partially overlapping in time with the first uplink transmission; and an uplink transmission from a different transmit antenna panel than the first uplink transmission.

According to a third aspect, a method for wireless communication comprises receiving, by a user device from a network device, at least one parameter for a first uplink transmission from the user device, the at least one parameter relating to at least one of one or more modulation orders or one or more coding rates for the first uplink transmission; and utilizing the at least one parameter for the first uplink transmission when a parallel uplink transmission is detected at the user device.

According to a fourth aspect, a method for wireless communication comprises determining, by a network device, at least one parameter to be used for a first uplink transmission from a user device when a parallel uplink transmission is detected at the user device, the at least one parameter relating to at least one of one or more modulation orders or one or more coding rates for the first uplink transmission; and transmitting, by the network device, the at least one parameter to the user device.

According to a fifth aspect, there is provided a computer program comprising instructions for causing an apparatus to perform at least the following: receiving, by a user device from a network device, at least one parameter for a first uplink transmission from the user device, the at least one parameter relating to at least one of one or more modulation orders or one or more coding rates for the first uplink transmission; and utilizing the at least one parameter for the first uplink transmission when a parallel uplink transmission is detected at the user device.

According to a sixth aspect, there is provided a computer program comprising instructions for causing an apparatus to perform at least the following: determining, by a network device, at least one parameter to be used for a first uplink transmission from a user device when a parallel uplink transmission is detected at the user device, the at least one parameter relating to at least one of one or more modulation orders or one or more coding rates for the first uplink transmission; and transmitting, by the network device, the at least one parameter to the user device.

According to a seventh aspect, a user device for wireless communication may comprise means for: receiving, from a network device, at least one parameter for a first uplink transmission from the user device, the at least one parameter relating to at least one of one or more modulation orders or one or more coding rates for the first uplink transmission; and utilizing the at least one parameter for the first uplink transmission when a parallel uplink transmission is detected at the user device.

According to an eighth aspect, a network device for wireless communication may comprise means for: determining at least one parameter to be used for a first uplink transmission from a user device when a parallel uplink transmission is detected at the user device, the at least one parameter relating to at least one of one or more modulation orders or one or more coding rates for the first uplink transmission; and transmitting the at least one parameter to the user device.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1A illustrates an example of a method for wireless communication according to an example embodiment.

FIG. 1B illustrates an example of a method for wireless communication according to an example embodiment.

FIG. 2A illustrates an overriding operation for a physical uplink shared channel according to an example embodiment.

FIG. 2B illustrates an overriding operation for a physical uplink shared channel according to another example embodiment.

FIG. 3A illustrates an overriding operation for a physical uplink control channel according to an example embodiment.

FIG. 3B illustrates an overriding operation for a physical uplink control channel according to another example embodiment.

FIG. 4 illustrates an example of an apparatus configured to practice one or more example embodiments.

FIG. 5 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

Some example embodiments of the present disclosure have been described in a specific data communication environment, for example, 3GPP mobile communication network environment. The present disclosure can, however, be applied in any existing or coming wireless communication environment.

In the following discussion, a term “parallel uplink transmission” is used. In an example embodiment, this term may correspond to having the uplink (UL) transmissions (or the corresponding resources) overlapping fully or partially in time. More generally, the parallel uplink transmission may comprise one or more of the following: an uplink transmission in a same serving cell or same bandwidth part as the first uplink transmission; an uplink transmission at least partially overlapping in time with the first uplink transmission; and an uplink transmission from a different transmit antenna panel than the first uplink transmission.

In another example embodiment, if one of the uplink transmissions is a physical random access channel (PRACH) transmission, the term “parallel” or “overlap” may not necessarily mean that the PRACH transmission and the other UL transmission are overlapping in time. It may mean that the PRACH and UL transmission are in the same slot or are at most a number of symbols distant from each other (in the time domain). Further, the parallel UL transmissions may be in the same serving cells or bandwidth part (or in different serving cells or bandwidth part). In a case when supplementary uplink (SUL) is configured, the parallel UL transmissions may be in the same carrier or in different carriers (in the same cell). The parallel UL transmissions may be in the same cell or in cells having different physical cell ID. The parallel UL transmissions may be transmitted with different antenna panels (or different UL beams).

Further, the term “UL beam” used herein may also refer to spatial relation information, a (separate) UL transmission configuration indicator (TCI) state, a joint or common TCI state, a spatial filter, power control information (or a power control parameters set), a panel or a panel ID etc. These terms may be interchangeably used in the description below. Further, a user equipment (UE) panel may be identified by a panel ID. Alternatively, or additionally, a panel may be identified or associated by at least one downlink (DL) reference signal (RS) (or more generally RS) or simply by an UL beam. Further, the beam information for PUCCH and/or PUSCH discussed herein may be indicated/configured either based on the Rel-15/Rel-16 framework or on the Rel-17 unified TCI framework.

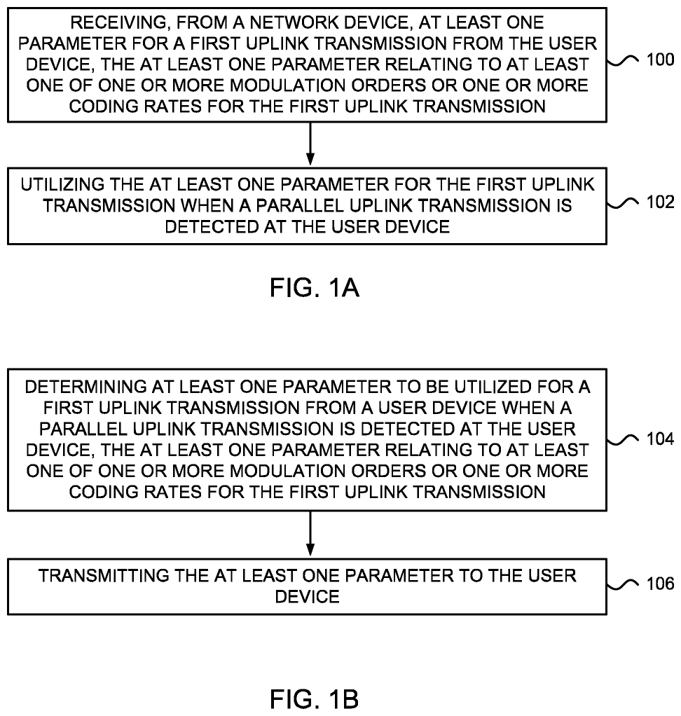

FIG. 1A illustrates an example of a method for wireless communication according to an example embodiment. The method may be performed by a user device, for example, user equipment.

A step 100 comprises receiving, from a network device, at least one parameter for a first uplink transmission from the user device, the at least one parameter relating to at least one of one or more modulation orders or one or more coding rates for the first uplink transmission. The at least one parameter may comprise, for example, at least one of the following: a modulation and coding scheme, a modulation and coding scheme offset, a modulation and coding scheme table, a modulation order, a coding rate, a maximum code rate, and a maximum number of physical resource blocks.

A step 102 comprises utilizing the at least one parameter for the first uplink transmission when a parallel uplink transmission is detected at the user device. In an example embodiment, the first uplink transmission may comprise a physical uplink control channel (PUCCH) or a physical uplink shared channel (PUSCH), and the parallel uplink transmission may comprise a PUCCH, PUSCH, a physical random access channel (PRACH) or a sounding reference signal (SRS).

FIG. 1B illustrates an example of a method for wireless communication according to an example embodiment. The method may be performed by a network device, for example, by a base station or a gNB, i.e. a 5 g/New Radio (NR) base station.

A step 104 comprises determining at least one parameter to be utilized for a first uplink transmission from a user device when a parallel uplink transmission is detected at the user device, the at least one parameter relating to at least one of one or more modulation orders or one or more coding rates for the first uplink transmission. The at least one parameter may comprise, for example, one or more of the following: a modulation and coding scheme, a modulation and coding scheme offset, a modulation and coding scheme table, a modulation order, a coding rate, a maximum code rate, and a maximum number of physical resource blocks.

A step 106 comprises transmitting the at least one parameter to the user device. In an example embodiment, the first uplink transmission may comprise a physical uplink control channel (PUCCH) or a physical uplink shared channel (PUSCH), and the parallel uplink transmission may comprise a PUCCH, PUSCH, a physical random access channel (PRACH) or a sounding reference signal (SRS).

In an example embodiment, when a PUSCH overlaps with another UL channel(s)/transmission(s) and the PUSCH and the other UL channel(s)/transmission(s) would be (or is) transmitted in parallel (for example, in a same (serving) cell), the at least one parameter may comprise a second (or a dedicated) modulation and coding scheme (MCS) to override a first modulation and coding scheme for the first uplink transmission. In an example embodiment, the user device may be configured override an initially configured or indicated MCS (i.e. the first MCS) for a physical uplink shared channel (PUSCH) with the second MCS, where this second MCS may be used in case the PUSCH overlaps with another uplink channel or channels.

In an example embodiment, the second MCS may be indicated to the user device via one or more of the following: a radio resource control (RRC), a new or an existing medium access control (MAC) control element (CE) or downlink control information (DCI). In an example embodiment of using DCI indication, the DCI scheduling the other UL channel(s), such as a downlink (DL) DCI scheduling a physical downlink shared channel (PDSCH) and corresponding to the PUCCH, that overlaps with the PUSCH, may be used to indicate the second MCS. In other example embodiments, other variants like DCI (re-)activating CG PUSCH Type 2, triggering sounding reference signal (SRS), triggering channel state information (CSI) reporting, or scheduling another PUSCH etc., may be used. In an example embodiment, it is possible to use a new DCI field or an existing/a reserved DCI field (or an entry). In an example embodiment, the DCI field may comprise a downlink control information scheduling the parallel uplink transmission. In an example embodiment, an MCS table indicated via a corresponding radio network temporary identifier (RNTI) (for the scheduled PUSCH), which is intended to look up an initially configured or indicated MCS, may be used to look up the second MCS.

In an example embodiment, the at least one parameter may comprise an MCS offset enabling the user device to determine a second modulation and coding scheme at least partly based on the MCS offset. In an example embodiment, the MCS offset may be indicated to the user device via at least one of a RRC, a new or an existing MAC CE or DCI. In an example embodiment, the MCS offset may indicate an offset value where this the offset value is added to or subtracted from an initial MCS value.

In an example embodiment, the at least one parameter may comprise at least one MCS table enabling. The user device may be configured to determine a second modulation and coding scheme at least partly based on the at least one modulation and coding scheme table for the first uplink transmission in case the PUSCH transmission overlaps with another UL transmission(s). The MCS table may be an MCS table that is associated with an another RNTI for PUSCH than the RNTI associated with a scheduled PUSCH (for example, a cell radio network temporary identifier (C-RNTI) associated PUSCH can use the MCS table that is associated with MCS-RNTI in case of overlapping UL transmission(s)). In an example embodiment, when a control resource set (CORESET) or CORESET group (or even a beam failure detection reference signal (BFD-RS) set) specific MCS table configurations are applied at the user device, the MCS table may be the table that has the greatest number of lower spectral efficiency (SE) entries among the configured MCS tables. Alternatively, in an example embodiment, the MCS table corresponding to the CORESET or CORESET group may be used. In an example embodiment, each MCS table may be associated to one other MCS table via RRC, and this other MCS table can be considered to be the MCS table to be used.

In an example embodiment, the first MCS may comprise an initially configured or indicated modulation and coding scheme for the first uplink transmission.

In an example embodiment, considering at least one of the above alternatives, if the user device is configured and/or indicated to use an existing MCS table for the PUSCH, and this MCS table is associated to a second MCS table, and the user device then determines to use the second MCS table (for example, due to an overlap of the PUSCH with another UL transmission(s)), then the user device may use the second MCS table associated with the existing MCS table.

In an example embodiment, when the PUSCH overlaps with another UL channel(s)/transmission(s) and the PUSCH and the other UL channel(s)/transmission(s) would be transmitted in parallel (for example, in a same (serving) cell), the at least one parameter may comprise a second modulation order or a second coding rate (i.e. one parameter). The user device may be configured to override a first modulation order or a first coding rate for the PUSCH, and the second modulation order or the second coding rate is used in case the PUSCH transmission overlaps with another UL transmission(s). The second modulation order or the second coding rate may be indicated to the user device via one or more of the following: a radio resource control (RRC), a new or an existing medium access control (MAC) control element (CE) or downlink control information (DCI).

In an example embodiment, when the PUSCH overlaps with another UL channel(s)/transmission(s) and the PUSCH and the other UL channel(s)/transmission(s) would be transmitted in parallel (for example, in a same (serving) cell), the user device may be configured to determine at least one of one or more parameters related to a phase tracking reference signal (PTRS) for the first uplink transmission, one or more parameters related to a transmission power value for the first uplink transmission or one or more parameters related to a transport block size (TBS) for the first uplink transmission at least partly based on the second modulation and coding scheme.

In an example embodiment, when the PUSCH overlaps with another UL channel(s)/transmission(s) and the PUSCH and the other UL channel(s)/transmission(s) would be transmitted in parallel (for example, in a same (serving) cell), the second MCS may be selected from a configured subset of MCS values (for example, a subset of MCS values from at least one of the configured MCS tables).

In an example embodiment, when a PUCCH overlaps with another UL channel(s)/transmission(s) and the PUCCH and the other UL channel(s)/transmission(s) would be (or is) transmitted in parallel (for example, in a same (serving) cell), the at least one parameter may comprise a second maximum code rate (maxCodeRate). The user device may be configured to override a first maximum code rate with the second maximum code rate, the second maximum code rate being used by the user device for at least one of uplink control information coding or the determination of a number of physical resource blocks (PRBs) for the PUCCH resource and corresponding PUCCH transmission.

In an example embodiment, the PUCCH resource (or the corresponding PUCCH format or set/group of PUCCH resources) may be associated via RRC (or MAC CE) with a second maxCodeRate to be used for overriding the initial/regular maxCodeRate.

In an example embodiment, the second maxCodeRate may be indicated via at least one of a RRC, a new or an existing MAC CE or DCI, such as UL DCI scheduling PUSCH overlapping with the PUCCH using a new DCI field or an existing/reserved DCI field (for example, by re-interpreting the beta_offset indicator) or an entry. Similarly, other variants, like DCI (re-)activating CG PUSCH Type 2, or triggering SRS, or triggering CSI reporting, or scheduling another PUCCH, etc. may be applied. In an example embodiment, the PUCCH resource (or a corresponding PUCCH format or a set/group of PUCCH resources) may be associated with at least two second maxCodeRates and the user device is indicated via DCI which second maxCodeRate to use. In an example embodiment, the indication via DCI may also have an entry indicating to use the initial maxCodeRate corresponding to the PUCCH resource.

In an example embodiment, the user device may determine the number of PRBs based on the initial maxCodeRate, and then the user device may determine the size of uplink control information (UCI), which can fit in the PUCCH resource based on the second maxCodeRate.

In an example embodiment, when the PUCCH overlaps with another UL channel(s)/transmission(s) and the PUCCH and the other UL channel(s)/transmission(s) would be transmitted in parallel (for example, in a same (serving) cell), a second maximum number of PRBs (for example, denoted as nrofPRBs) may be configured or indicated to the user device to override a first maximum number of PRBs for the first uplink transmission with the second maximum number of PRBs. The user device may be configured to determine the number of PRBs (at least for the PUCCH formats 2 and 3) based on the second maximum number of PRBs for the PUCCH resource and the corresponding PUCCH transmission. In an example embodiment, the user device may be configured to override a first maximum number of PRBs with the second maximum number of PRBs, determine the number of PRBs for the first uplink transmission at least partly based on the second maximum number of PRBs, and use the number of PRBs for the first uplink transmission.

In an example embodiment, the PUCCH resource (or the corresponding PUCCH format or set of PUCCH resources) may be associated via RRC (or MAC CE) with a second maximum number of PRBs to be used for overriding an initial/regular maxCodeRate.

In an example embodiment, the second maximum number of PRBs to use may be indicated via at least one of a RRC, a new or an existing MAC CE or DCI, such as UL DCI scheduling PUSCH overlapping with the PUCCH, using a new DCI field or an existing DCI field (for example, by re-interpreting the beta_offset indicator). Similarly, other variants like DCI (re-)activating CG PUSCH Type 2, triggering SRS, triggering CSI reporting or scheduling another PUCCH, etc. can be applied. In an example embodiment, the PUCCH resource (or the corresponding PUCCH format or a set/group of PUCCH resources) may be associated with at least two second maximum number of PRBs, and the user device is indicated via DCI, which second maximum number of PRBs to use. In an example embodiment, the indication via DCI may also have an entry indicating to use an initial maximum number of PRBs corresponding to the PUCCH resource.

In an example embodiment, when the PUCCH overlaps with another UL channel(s)/transmission(s) and the PUCCH and the other UL channel(s)/transmission(s) would be transmitted in parallel (for example, in a same (serving) cell), the user device may determine the maximum number of PRBs (for example, from a configured set of values), for example, to preserve an important UCI, such as a hybrid automatic repeat request acknowledgement (HARQ-ACK), a scheduling request (SR) and/or CSI part 1 (to avoid dropping this UCI). Further, the user device may determine the maxCodeRate (for example, from a configured set of values) in such a way to preserve an important UCI such as the HARQ-ACK, SR and/or CSI part (to avoid dropping this UCI).

In an example embodiment, any of the above discussed operations may be enabled/disabled by a base station, for example, a gNB, via at least one of a RRC, a new or an existing MAC CE, and/or a new or an existing/reserved DCI field. For example, the indication for enabling/disabling an operation for the PUCCH can be indicated via an UL DCI scheduling PUSCH overlapping with the PUCCH using a new DCI field or an existing DCI field (for example, by re-interpreting the beta_offset indicator). In another example embodiment, the indication for enabling/disabling an operation for the PUSCH can be indicated via a DL DCI scheduling PUCCH overlapping with the PUSCH using a new DCI field or an existing DCI field.

In an example embodiment, in case of a PUSCH/PUCCH repetition operation, the above discussed operation for the PUSCH/PUCCH may be applied if (i) at least one PUSCH/PUCCH repetition overlaps (in time) with one or more UL transmissions (and/or repetitions), and these overlapping transmissions would be transmitted in parallel, or if (ii) at least a certain configured (or indicated) number of PUSCH/PUCCH repetitions overlap (at least in time) with one or more UL transmissions (and/or repetitions), and these overlapping transmissions would be transmitted in parallel. For (ii), the configured number of PUSCH/PUCCH repetitions may be defined as an integer or as a percentage/ratio of the (configured/indicated) PUSCH/PUCCH repetition factor. For example, in case of a percentage/ratio, if the configured number of PUSCH repetitions is defined as 50% and the PUSCH repetition factor is 4, then the proposed PUSCH operation may apply only if there is at least 50% of the total number of repetition (i.e. the repetition factor) overlapping with one or more UL transmissions, i.e. if there is at least 2 PUSCH repetitions overlapping with one or more UL transmissions.

Further, in an example embodiment, for each of the PUCCH and PUSCH, there may be a timeline condition or timeline conditions defined that enables the user device to change, for example, the maxCodeRate or MCS with respect to the corresponding proposed operation above. When considering the above discussed PUCCH operation, and when the PUCCH overlaps with a dynamically scheduled PUSCH, the PDCCH scheduling the PUSCH may need to be received at least a certain (predefined) time before the first symbol of the PUCCH (or before the first symbol of the earlier channel between PUCCH and PUSCH). Similarly, when considering the above discussed PUSCH operation, and when the PUSCH overlaps with a PUCCH that has a corresponding PDCCH, the PDCCH corresponding to the PUCCH may need to be received at least a certain (predefined) time before the first symbol of the PUSCH (or before the first symbol of the earlier channel between the PUCCH and PUSCH).

In an example embodiment, in case of multi transmission reception point (TRP) PUCCH/PUSCH time division multiplexing (TDM) repetition operation, where PUCCH/PUSCH repetitions are transmitted towards two TRPs using two UL beams, spatial relation information or two SRS resource indicators (or two power control parameters sets, or two UL TCI states), the above discussed PUSCH/PUCCH operation may be applicable to all PUCCH/PUSCH repetitions. In an example embodiment, the above discussed PUSCH/PUCCH operation may be applicable only to PUCCH/PUSCH repetitions corresponding to one of the two UL beams, for example, when only the PUCCH/PUSCH repetitions using this UL beam are overlapping with one or more UL transmissions (and these overlapping transmissions would be transmitted in parallel).

In an example embodiment for the PUCCH, a second modulation order/type (such as QPSK or Pi/2-BPSK, BPSK) may alternatively or additionally be configured or indicated to the user device to override a first modulation order/type, where the second modulation order/type is used in case the PUCCH transmission overlaps with another UL transmission(s). The examples discussed above for how to indicate or determine the second maxCodeRate may be used also here to indicate the second modulation order/type.

In an example embodiment, the first modulation order or the first coding rate, the first maximum code rate or the first maximum number of physical resource blocks comprises an initially configured or indicated modulation order or an initially configured or indicated coding rate, an initially configured or indicated maximum code rate or an initially configured or indicated maximum number of physical resource blocks for the first uplink transmission respectively.

In an example embodiment, although various operations and examples have been discussed in relation to overlapping UL transmissions, these operations and examples may also be used in other scenarios. For example, in case of maximum permissible exposure (MPE) event or coverage limited scenario. Further, for these scenarios, the decision whether to apply or not at least one of the operations may be left up to the UE or it could be at least partially controlled by the network device.

In an example embodiment, a power reduction operation may be partially up to a user device implementation, at least one of the above discussed operations and examples may be decided by the user device. Further, in an example embodiment, the user device may indicate to the network device whether an operation has been applied or not. This indication may be carried via dedicated demodulation reference signal (DMRS) information, such as a dedicated DMRS sequence, a dedicated orthogonal cover code (OCC) for the DMRS or dedicated time (and/or frequency) resources for the DMRS, for the PUCCH/PUSCH or via UCI separately encoded and included in the PUCCH/PUSCH. The decision whether to apply at least one of the above discussed operations and examples may depend on whether the PUCCH/PUSCH power reduction would occur or whether the PUCCH/PUSCH power reduction is larger than a preconfigured offset or below a preconfigured threshold.

In an example embodiment, when parallel UL transmissions are intended to be received at different TRPs, an additional level of coordination signaling may be needed to determine the overriding operation performed by the user device. In an example embodiment, for example, if an UL DCI sent by a TRP1 schedules a PUSCH transmission and a DL DCI sent by a TRP2 schedules a PUCCH transmission where the PUCCH and PUSCH overlap in time, and the UL DCI would result in one of the overriding operation proposed above for PUCCH, the TRP1 may indicate at least some of the scheduling parameters of PUSCH towards the TRP2 such that TRP2 understands the possibility of UE changing some parameters (such as maxCodeRate) for the PUCCH transmission. In an example embodiment, such scheduling parameters of the PUSCH may be sent towards the TRP2 as soon as PUSCH scheduling parameters are decided by the TRP1. In another example embodiment, if the DL DCI would result in one of the overriding operation discussed above for the PUSCH, the TRP2 may indicate at least some of the scheduling parameters of the PUCCH towards the TRP1 such that the TRP1 understands the possibility of the user device changing some parameters (such as MCS) for the PUSCH transmission.

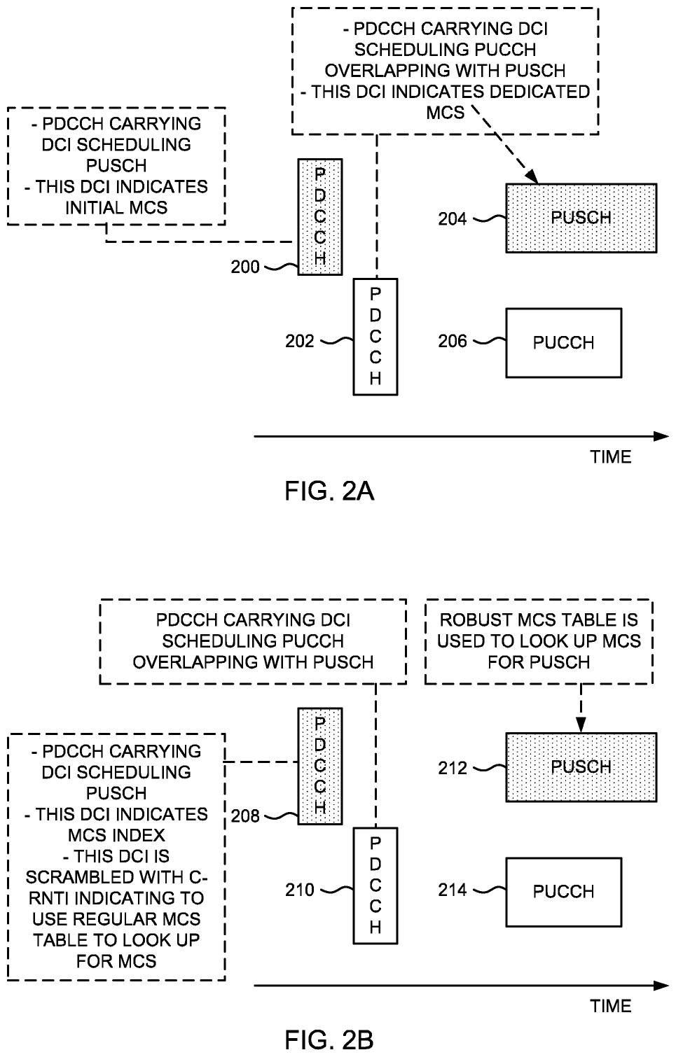

FIG. 2A illustrates, for a user device, an overriding operation for a physical uplink shared channel (PUSCH) according to an example embodiment.

A PDCCH 200 is carrying a DCI scheduling a PUSCH 204 where this 204 PUSCH overlaps with a PUCCH 206 that has a corresponding PDCCH 202. The PDCCH 200 of the PUSCH 204 is sent earlier than the PDCCH 202 of the PUCCH 206. In addition, the DCI/PDCCH 200 scheduling the PUSCH 204 indicates a first MCS (i.e. an initial MCS).

Due to the overlap with PUCCH 206, the DCI corresponding to the PUCCH 206 indicates a second MCS (i.e. a dedicated MCS) to override the initially indicated MCS in the DCI/PDCCH 200 scheduling the PUSCH 204, and the user device uses the second MCS for the PUSCH 204 and discards the first MCS.

FIG. 2B illustrates, for a user device, an overriding operation for a physical uplink shared channel (PUSCH) according to another example embodiment.

A PDCCH 208 is carrying a DCI scheduling a PUSCH 212 where the PUSCH 212 overlaps with a PUCCH 214 that has a corresponding PDCCH 210, where the PDCCH 208 of the PUSCH 212 is sent earlier than the PDCCH 210 of the PUCCH 214. Further, the user device is configured with two MCS tables, a regular MCS table and a robust MCS table. Further, the DCI/PDCCH 208 scheduling the PUSCH 212 indicates a second MCS (i.e. a dedicated MCS) and is scrambled with C-RNTI which indicates that the regular MCS table should be used to look up the MCS.

Due to the overlap with the PUCCH 214, the user device uses the robust MCS table instead of the regular MCS table in order to look up for the MCS for PUSCH 212.

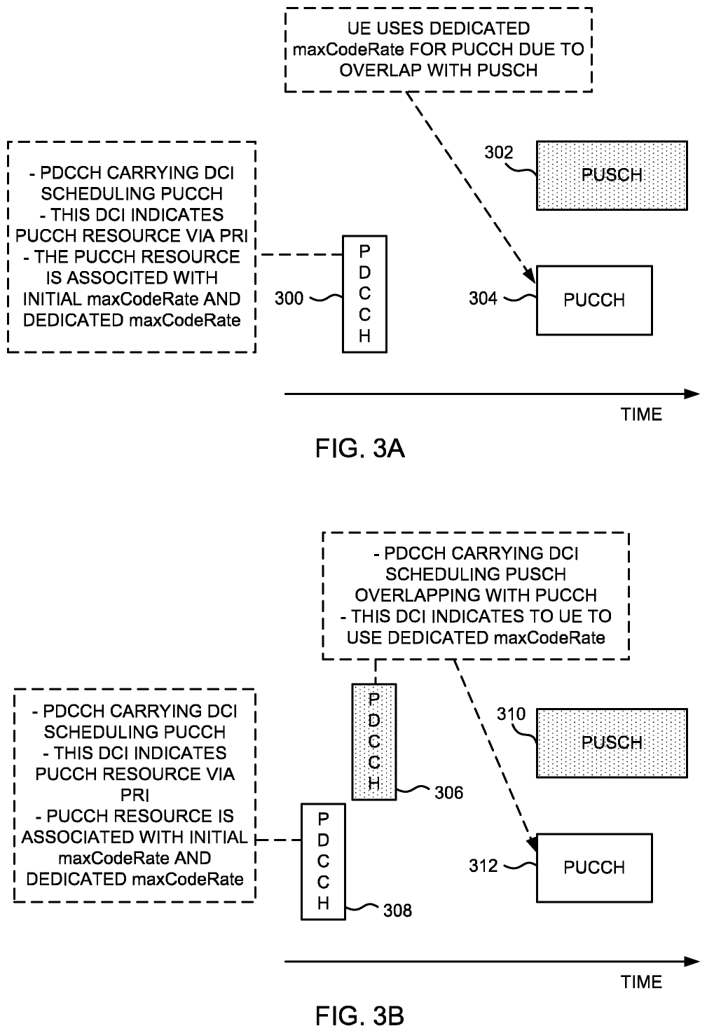

FIG. 3A illustrates, for a user device, an overriding operation for a physical uplink control channel (PUCCH) according to an example embodiment.

A PDCCH 300 corresponds to or schedules a PUCCH 304 where the PUCCH 304 overlaps with a PUSCH 302 (which may be, for example, a configured-grant PUSCH). The user device determines the PUCCH 304 resource based on at least a PRI indicated in the DL DCI (corresponding to the PUCCH 304) and the UCI payload size. The PUCCH 304 resource is configured via RRC with a second maxCodeRate (i.e. a dedicated maxCodeRate), in addition to a regular maxCodeRate.

Due to the overlap with the PUSCH 302, the user device uses the second maxCodeRate (instead of the regular maxCodeRate) for the PUCCH 304.

FIG. 3B illustrates, for a user device, an overriding operation for a physical uplink control channel (PUCCH) according to another example embodiment.

A PDCCH 308 schedules a PUCCH 312 where the PUCCH 312 overlaps with a PUSCH 310 scheduled with a PDCCH 306, and the PDCCH 308 of the PUCCH 312 is sent earlier than the PDCCH 306 of the PUSCH 312. The user device determines the PUCCH 312 resource based on at least the PRI indicated in the DL DCI (corresponding to the PUCCH 312) and the UCI payload size. The PUCCH 312 resource is configured via RRC with a second maxCodeRate (i.e. a dedicated maxCodeRate), in addition to a regular maxCodeRate.

Due to the overlap of the PUCCH with the PUSCH 310, the UL DCI scheduling the PUSCH 310 indicates to the user device to use the second maxCodeRate (instead of the regular maxCodeRate) for the PUCCH 312. This indication may be carried, for example, using a new DCI field (for example, a 1-bit field) or an existing DCI field, such as beta_offset indicator field.

One or more of the above discussed examples and example embodiment may enable a solution to avoid a negative impact of a potential PUSCH/PUCCH power reduction due to, for example, parallel (or simultaneous) uplink transmissions. Further, one or more of the above discussed examples and example embodiments may enable a solution to guarantee reliability and correct reception of the PUCCH/PUSCH in case of parallel UL transmissions. One or more of the above discussed examples and example embodiments may enable a solution that helps in case of limited coverage as well as MPE events.

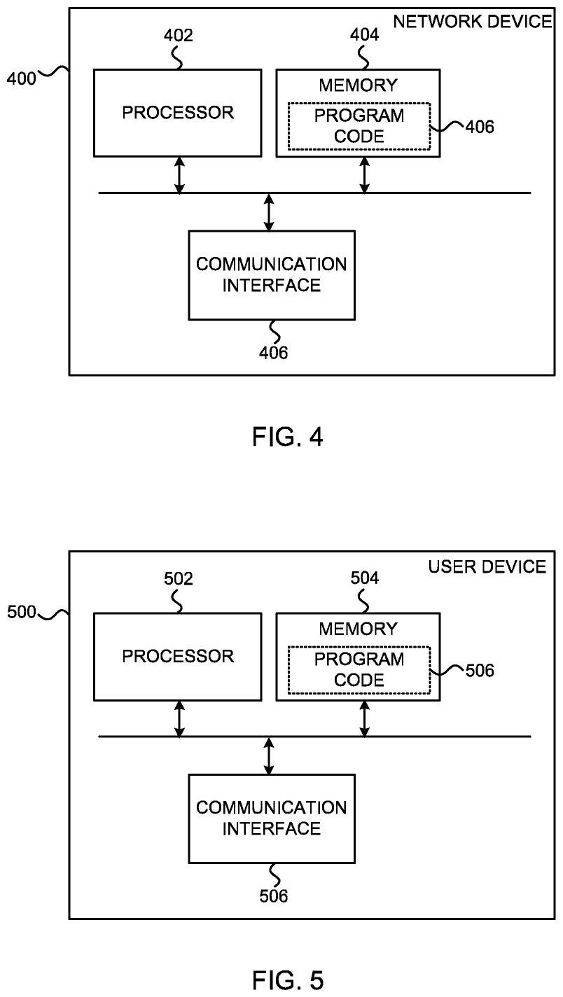

FIG. 4 illustrates an example of an apparatus 400 configured to practice one or more example embodiments. The apparatus 400 may comprise a base station or a gNB of a wireless communication network. The apparatus 400 may comprise at least one processor 402. The at least one processor 402 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 400 may further comprise at least one memory 404. The at least one memory 404 may be configured to store, for example, computer program code or the like, for example, operating system software and application software. The at least one memory 404 may comprise one or more volatile memory devices, one or more non-volatile memory devices, and/or a combination thereof. For example, the at least one memory 404 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 400 may further comprise a communication interface 408 configured to enable apparatus 400 to transmit and/or receive information to/from other devices. In one example, the apparatus 400 may use the communication interface 408 to transmit or receive signaling information and data in accordance with at least one data communication or cellular communication protocol. The communication interface 408 may be configured to provide at least one wireless radio connection, such as, for example, a 3GPP mobile broadband connection (e.g. 3G, 4G, 5G, 6G etc.). In another example embodiment, the communication interface 408 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 408 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 400 is configured to implement some functionality, some component and/or components of the apparatus 400, for example, the at least one processor 402 and/or the at least one memory 404, may be configured to implement this functionality. Furthermore, when the at least one processor 402 is configured to implement some functionality, this functionality may be implemented using the program code 406 comprised, for example, in the at least one memory 404.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 400 may comprise means for performing at least one method described herein. In an example embodiment, the means may comprise the at least one processor 402, the at least one memory 404 including program code 406 configured to, when executed by the at least one processor, cause the apparatus 400 to perform the method.

The apparatus 400 may comprise, for example, a computing device, for example, a base station, a server, a network or the like. Examples of IoT devices include, but are not limited to, consumer electronics, wearables, sensors, and smart home appliances. Although the apparatus 400 is illustrated as a single device it is appreciated that, wherever applicable, functions of the apparatus 400 may be distributed to a plurality of devices, for example, to implement example embodiments as a cloud computing service.

An apparatus, for example, a device such as a user equipment, a user device, a user node, a mobile device, an IoT node, a network node or a cloud node may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

FIG. 4 illustrates an example of an apparatus 400 configured to practice one or more example embodiments. The apparatus 400 may comprise at least one processor 402. The at least one processor 402 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 400 may further comprise at least one memory 404. The at least one memory 404 may be configured to store, for example, computer program code or the like, for example, operating system software and application software. The at least one memory 404 may comprise one or more volatile memory devices, one or more non-volatile memory devices, and/or a combination thereof. For example, the at least one memory 404 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 400 may further comprise a communication interface 408 configured to enable apparatus 400 to transmit and/or receive information to/from other devices. In one example, the apparatus 400 may use the communication interface 408 to transmit or receive signaling information and data in accordance with at least one data communication or cellular communication protocol. The communication interface 408 may be configured to provide at least one wireless radio connection, such as, for example, a 3GPP mobile broadband connection (e.g. 3G, 4G, 5G, 6G etc.). In another example embodiment, the communication interface 408 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 408 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 400 is configured to implement some functionality, some component and/or components of the apparatus 400, for example, the at least one processor 402 and/or the at least one memory 404, may be configured to implement this functionality. Furthermore, when the at least one processor 402 is configured to implement some functionality, this functionality may be implemented using the program code 406 comprised, for example, in the at least one memory 404.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 400 may comprise means for performing at least one method described herein. In an example embodiment, the means may comprise the at least one processor 402, the at least one memory 404 including program code 406 configured to, when executed by the at least one processor, cause the apparatus 400 to perform the method.

The apparatus 400 may comprise, for example, a computing device, for example, a base station, a gNB, a server, a network device or the like. Although the apparatus 400 is illustrated as a single device it is appreciated that, wherever applicable, functions of the apparatus 400 may be distributed to a plurality of devices, for example, to implement example embodiments as a cloud computing service.

FIG. 5 illustrates an example of an apparatus 500 configured to practice one or more example embodiments. The apparatus 500 may comprise at least one processor 502. The at least one processor 502 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 500 may further comprise at least one memory 504. The at least one memory 504 may be configured to store, for example, computer program code or the like, for example, operating system software and application software. The at least one memory 504 may comprise one or more volatile memory devices, one or more non-volatile memory devices, and/or a combination thereof. For example, the at least one memory 504 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 500 may further comprise a communication interface 508 configured to enable apparatus 500 to transmit and/or receive information to/from other devices. In one example, the apparatus 500 may use the communication interface 508 to transmit or receive signaling information and data in accordance with at least one data communication or cellular communication protocol. The communication interface 508 may be configured to provide at least one wireless radio connection, such as, for example, a 3GPP mobile broadband connection (e.g. 3G, 4G, 5G, 6G etc.). In another example embodiment, the communication interface 508 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 508 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 500 is configured to implement some functionality, some component and/or components of the apparatus 500, for example, the at least one processor 502 and/or the at least one memory 504, may be configured to implement this functionality. Furthermore, when the at least one processor 502 is configured to implement some functionality, this functionality may be implemented using the program code 506 comprised, for example, in the at least one memory 504.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUs).

The apparatus 500 may comprise means for performing at least one method described herein. In an example embodiment, the means may comprise the at least one processor 502, the at least one memory 504 including program code 506 configured to, when executed by the at least one processor, cause the apparatus 500 to perform the method.

The apparatus 500 may comprise, for example, a computing device, for example, a mobile device, a mobile phone, a user device, a user equipment, a user node, a tablet computer, a laptop, an internet of things (IoT) device, a tag, or the like. Examples of IoT devices include, but are not limited to, consumer electronics, wearables, sensors, and smart home appliances. Although the apparatus 500 is illustrated as a single device it is appreciated that, wherever applicable, functions of the apparatus 500 may be distributed to a plurality of devices, for example, to implement example embodiments as a cloud computing service.

An apparatus, for example, a device such as a user equipment, a user device, a user node, a mobile device, an IoT node, a network device, a network node, a base station, a gNB or a cloud node may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A user device for wireless communication, comprising:
at least one processor; and
at least one memory including computer program code, the at least one memory and the computer program code configured to, with the at least one processor, cause the user device at least to:
receive, from a network device, at least one parameter for a first uplink transmission from the user device, the at least one parameter relating to at least one of one or more modulation orders or one or more coding rates for the first uplink transmission; and
utilize the at least one parameter for the first uplink transmission when a parallel uplink transmission is detected at the user device.

2. The user device according to claim 1, wherein the at least one parameter comprises a second modulation and coding scheme and the utilizing of the at least one parameter comprises:
overriding a first modulation and coding scheme for the first uplink transmission with the second modulation and coding scheme.

3. The user device according to claim 1, wherein the at least one parameter comprises a modulation and coding scheme offset to a first modulation and coding scheme for the first uplink transmission and the utilizing of the at least one parameter comprises:
determining a second modulation and coding scheme at least partly based on the modulation and coding scheme offset; and
overriding the first modulation and coding scheme for the first uplink transmission with the second modulation and coding scheme.

4. The user device according to claim 1, wherein the at least one parameter comprises at least one modulation and coding scheme table and the utilizing of the at least one parameter comprises:
determining a second modulation and coding scheme at least partly based on the at least one modulation and coding scheme table; and
overriding a first modulation and coding scheme for the first uplink transmission with the second modulation and coding scheme.

5. The user device according to claim 2, wherein the first modulation and coding scheme comprises an initially configured or indicated modulation and coding scheme for the first uplink transmission.

6. The user device according to claim 1, wherein the at least one memory and the computer program code are configured to, with the at least one processor, cause the user device at least to:
determine at least one of one or more parameters related to a phase tracking reference signal (PTRS) for the first uplink transmission, one or more parameters related to a transmission power value for the first uplink transmission or one or more parameters related to a transport block size (TBS) for the first uplink transmission at least partly based on the second modulation and coding scheme.

7. The user device according to claim 1, wherein the at least one parameter comprises a second modulation order or a second coding rate and the utilizing of the at least one parameter comprises:
overriding a first modulation order or a first coding rate for the first uplink transmission with the second modulation order or the second coding rate respectively.

8. The user device according to claim 1, wherein the at least one parameter comprises a second maximum code rate and the utilizing of the at least one parameter comprises:
overriding a first maximum code rate for the first uplink transmission with the second maximum code rate.

9. The user device according to claim 1, wherein the at least one parameter comprises a set of maximum code rates and the utilizing of the at least one parameter comprises:
determining a second maximum code rate at least partly based on the set of maximum code rates; and
overriding a first maximum code rate for the first uplink transmission with the second maximum code rate.

10. The user device according to claim 1, wherein the at least one parameter comprises a second maximum number of physical resource blocks and the utilizing of the at least one parameter further comprises:
overriding a first maximum number of physical resource blocks for the first uplink transmission with the second maximum number of physical resource blocks; and
determining the number of physical resource blocks for the first uplink transmission at least partly based on the second maximum number of physical resource blocks.

11. The user device according to claim 1, wherein the at least one parameter comprises a set of maximum number of physical resource blocks and the utilizing of the at least one parameter further comprises:
determining a second maximum number of physical resource blocks at least partly based on the set of maximum number of physical resource blocks; and
overriding a first maximum number of physical resource blocks for the first uplink transmission with the second maximum number of physical resource blocks.

12. The user device according to claim 7, wherein the first modulation order or the first coding rate, the first maximum code rate or the first maximum number of physical resource blocks comprises an initially configured or indicated modulation order or an initially configured or indicated coding rate, an initially configured or indicated maximum code rate or an initially configured or indicated maximum number of physical resource blocks for the first uplink transmission respectively.

13. The user device according to claim 1, wherein the at least one memory and the computer program code are configured to, with the at least one processor, cause the user device at least to:
receive the at least one parameter via at least one of a radio resource control (RRC) parameter, a medium access control control element (MAC CE) or a downlink control information (DCI).

14. The user device according to claim 1, wherein the at least one memory and the computer program code are configured to, with the at least one processor, cause the user device at least to:
transmit an indication, to the network device, indicating whether the at least one parameter is in use at the user device.

15. The user device according to claim 1, wherein the first uplink transmission comprises a physical uplink control channel (PUCCH) transmission or a physical uplink shared channel (PUSCH) transmission, and the parallel uplink transmission comprises at least one of a PUCCH transmission, a PUSCH transmission, a physical random access channel (PRACH) transmission or a sounding reference signal (SRS) transmission.

16. The user device according to claim 1, wherein the parallel uplink transmission comprises one or more of the following:
an uplink transmission in a same serving cell or same bandwidth part as the first uplink transmission;
an uplink transmission at least partially overlapping in time with the first uplink transmission; and
an uplink transmission from a different transmit antenna panel than the first uplink transmission.

17. A network device for wireless communication, comprising:
at least one processor; and
at least one memory including computer program code, the at least one memory and the computer program code configured to, with the at least one processor, cause the network device at least to:
determine at least one parameter to be utilized for a first uplink transmission from a user device when a parallel uplink transmission is detected at the user device, the at least one parameter relating to at least one of one or more modulation orders or one or more coding rates for the first uplink transmission; and
transmit the at least one parameter to the user device.

18-24. (canceled)

25. The network device according to claim 17, wherein the at least one memory and the computer program code are configured to, with the at least one processor, cause the network device at least to:
transmit the at least one parameter to the user device via at least one of a radio resource control (RRC) parameter, a medium access control control element (MAC CE) or a downlink control information (DCI).

26. (canceled)

27. The network device according to claim 17, wherein the at least one memory and the computer program code are configured to, with the at least one processor, cause the network device at least to:
receive an indication from the user device indicating whether the at least one parameter is in use at the user device.

28-29. (canceled)

30. A method for wireless communication, comprising:
receiving, by a user device from a network device, at least one parameter for a first uplink transmission from the user device, the at least one parameter relating to at least one of one or more modulation orders or one or more coding rates for the first uplink transmission; and
utilizing the at least one parameter for the first uplink transmission when a parallel uplink transmission is detected at the user device.

31-33. (canceled)
